(19) United States
(12) Patent Application Publication
(10) Pub. No.: US 2026/0205554 A1
(43) Pub. Date: Jul. 16, 2026

(54) PRINT JOB MANAGEMENT METHOD, PRINT JOB MANAGEMENT APPARATUS AND STORAGE MEDIUM

(71) Applicant: Konica Minolta, Inc., Tokyo (JP)

(72) Inventor: Kouyo SUZUKI, Tokyo (JP)

(21) Appl. No.: 19/446,391

(22) Filed: Jan. 12, 2026

(30) Foreign Application Priority Data
Jan. 15, 2025 (JP) 2025-005315

(51) Int. Cl. H04N 1/60; H04N 1/54

(52) U.S. Cl. CPC H04N 1/603; H04N 1/54; H04N 1/6008

(57) ABSTRACT

A print job management method for managing a print job to be executed on an image forming engine, the method including: acquiring information of a first scanner profile for converting read data of a printed material of which image formation is performed under a first image formation condition; setting the first scanner profile in association with the first image formation condition, based on the acquired information of the first scanner profile; acquiring information of a second scanner profile for converting the read data of the printed material of which the image formation is performed under a second image formation condition; and setting the second scanner profile in association with the second image formation condition based on the acquired information of the second scanner profile.

### CROSS-REFERENCE TO RELATED APPLICATION

The entire disclosure of Japanese Patent Application No. 2025-005315, filed on January 15, 2025, including description, claims, drawings and abstract is incorporated herein by reference.

### BACKGROUND OF THE INVENTION

### TECHNICAL FIELD

The present disclosure relates to a print job management method, a print job management apparatus, and a storage medium.

### DESCRIPTION OF RELATED ART

In color management of a printed material of which image formation is performed by an image forming apparatus, a scanner installed on a conveyance route of the printed material is used. Read data (RGB value) read by the scanner is converted into a colorimetric value (L^{*}a^{*}b^{*} value, XYZ value, and the like) by a scanner profile. A color measurement result based on reading using the scanner is lower in accuracy than color measurement by an optical colorimeter. Therefore, for example, a scanner is calibrated on the basis of a result of the color measurement performed by the optical colorimeter, thereby suppressing a decrease in reading accuracy of the scanner (see Japanese Unexamined Patent Publication No. 2015-226128).

However, with the advance of image forming technologies, variations in image formation processes have increased, such as printing using a special color, decorative printing, and printing using special sheets. On the other hand, an optimal scanner profile varies depending on under what image formation conditions the printed material has undergone image formation. For this reason, in color management (color adjustment, color verification, and the like) using the scanner, even if calibration is performed using the optical colorimeter described above, it is difficult to satisfy customers' needs for high print quality.

### SUMMARY OF THE INVENTION

The present disclosure has been made in consideration of the above-described problem in the conventional technology, and an object thereof is to use a scanner profile suitable for each image formation condition.

In order to solve the above-described problem, according to one aspect of the present disclosure, a print job management method reflecting one aspect of the present disclosure is the print job management method for managing a print job to be executed on an image forming engine, the method including:

acquiring information of a first scanner profile for converting read data of a printed material of which image formation is performed under a first image formation condition;

setting the first scanner profile in association with the first image formation condition, based on the acquired information of the first scanner profile;

acquiring information of a second scanner profile for converting the read data of the printed material of which the image formation is performed under a second image formation condition; and setting the second scanner profile in association with the second image formation condition based on the acquired information of the second scanner profile.

According to another aspect of the present disclosure, a print job management apparatus reflecting one aspect of the present disclosure includes a hardware processor that executes the above-described print job management method.

According to another aspect of the present disclosure, a non-transitory computer readable storage medium reflecting one aspect of the present disclosure includes a program that causes a computer that controls a print job management apparatus to execute the above-described print job management method.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a configuration diagram of a color management system according to a first embodiment of the present disclosure;

FIG. 2 is a diagram illustrating a hardware configuration of an image forming apparatus;

FIG. 3 is a diagram illustrating an outer appearance configuration of the image forming apparatus;

FIG. 4 is a diagram illustrating a hardware configuration of a PC;

FIG. 5 is a diagram showing a hardware configuration of a printer controller;

FIG. 6 is a diagram showing a hardware configuration of a color management apparatus;

FIG. 7 is an example of a correspondence table illustrating a correspondence relationship between a profile name and profile data;

FIG. 8 is an example of a correspondence table illustrating a correspondence relationship between image formation conditions and profile names;

FIG. 9 is a diagram illustrating an example in which different image formation conditions are set for respective regions constituting print data;

FIG. 10 is a diagram illustrating an example of a scanner profile applied to each region of read data;

FIG. 11 is a ladder chart illustrating inspection processing executed in the PC and the image forming apparatus;

FIG. 12 is an example of a job management screen displayed on the PC;

FIG. 13 is a flowchart illustrating scanner profile setting processing;

FIG. 14 is a flowchart illustrating the scanner profile setting processing;

FIG. 15 is a ladder chart illustrating color parameter creation processing executed in the color management apparatus and the image forming apparatus according to the second embodiment;

FIG. 16 is an example of a color parameter creation screen displayed on the color management apparatus;

FIG. 17 is a ladder chart showing a color verification process executed in the color management apparatus and the image forming apparatus according to the third embodiment;

FIG. 18 is an example of a setting screen for color verification displayed on the color management apparatus;

FIG. 19 is a ladder chart showing color matching processing based on a color sample executed in the color management apparatus and the image forming apparatus according to the fourth embodiment; and

FIG. 20 is a ladder chart showing the color matching processing based on the color sample executed in the color management apparatus and the image forming apparatus according to the fourth embodiment.

### DETAILED DESCRIPTION

Hereinafter, one or more embodiments of the present disclosure will be described with reference to the drawings. However, the scope of the invention is not limited to the disclosed embodiments.

In the following, embodiments of the present disclosure will be described with reference to the drawings. The advantages and features provided by the embodiment will be understood from the following detailed description and the drawings. However, the scope of the present disclosure is not limited to the embodiment disclosed below or the examples illustrated in the drawings.

### First Embodiment

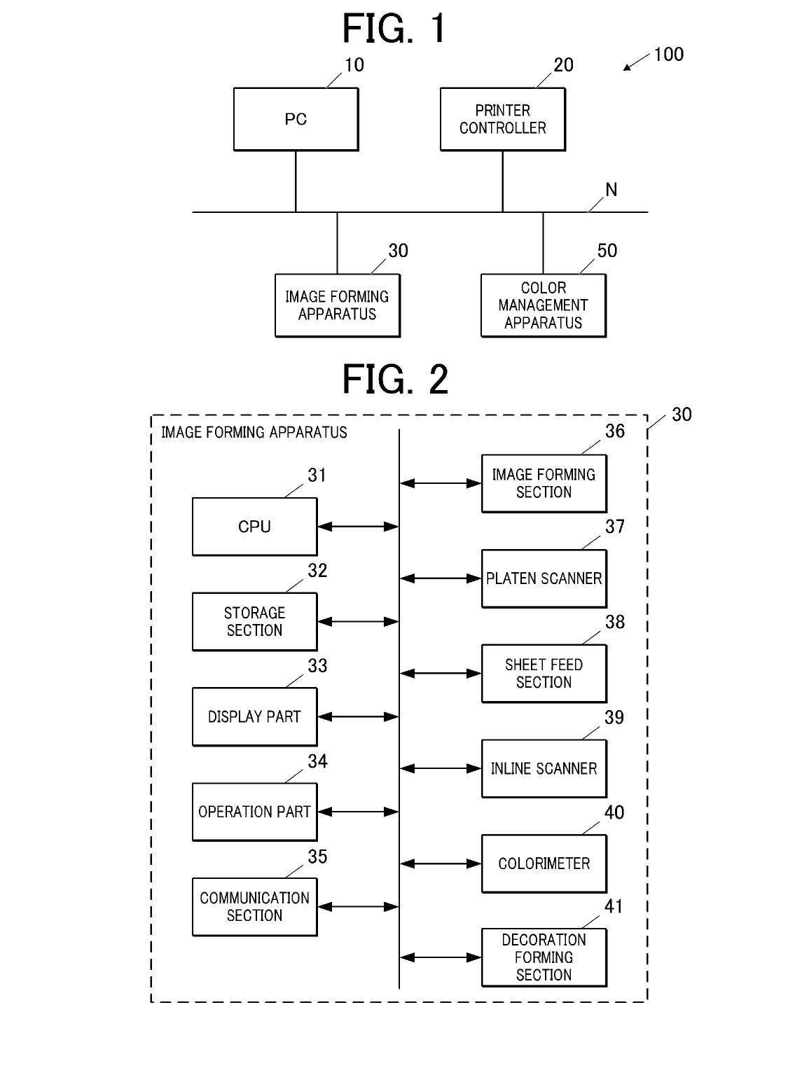

FIG. 1 shows a configuration of a color management system 100 according to the first embodiment. The color management system 100 includes a personal computer (PC) 10, a printer controller 20, an image forming apparatus 30, and a color management apparatus 50. The devices constituting the color management system 100 are connected via a communication network N such as a LAN (Local Area Network) so as to be able to perform data communication. Note that the number of devices is not particularly limited. The color management system 100 is used, for example, in a print shop or the like that provides printed material to customers.

A printer driver program 121 (see FIG. 4) is installed in the PC 10. The PC 10 issues a print instruction to the printer controller 20 or the image forming apparatus 30 by the printer driver. Specifically, the PC 10 generates print instruction data such as page description language (PDL) interpretable by the printer controller 20 in response to an operator's operation. The printer PC 10 transmits the generated print instruction data to the printer controller 20.

A printer controller program 221 (see FIG. 5) is installed in the printer controller 20. The printer controller 20 accepts the print instruction data from the PC 10. Furthermore, the printer controller 20 receives chart data from the color management apparatus 50. The printer controller 20 performs raster image processing (RIP) on the print instruction data or the chart data and generates image data for printing (raster data). Further, the printer controller 20 performs image processing such as color conversion and screening on the image data for printing. The printer controller 20 transmits the image data (raster data) after the image processing to the image forming apparatus 30.

The printer controller 20 may be built in the image forming apparatus 30. The printer controller 20 and the image forming apparatus 30 may be connected to each other via a dedicated line such as a PCI connection.

The image forming apparatus 30 forms an image on a sheet based on the raster data (image data in a bitmap format). The sheet includes printing sheets and various films. Examples of the type of sheet include plain paper, high-quality paper, gloss coated sheet, and matt coated sheet.

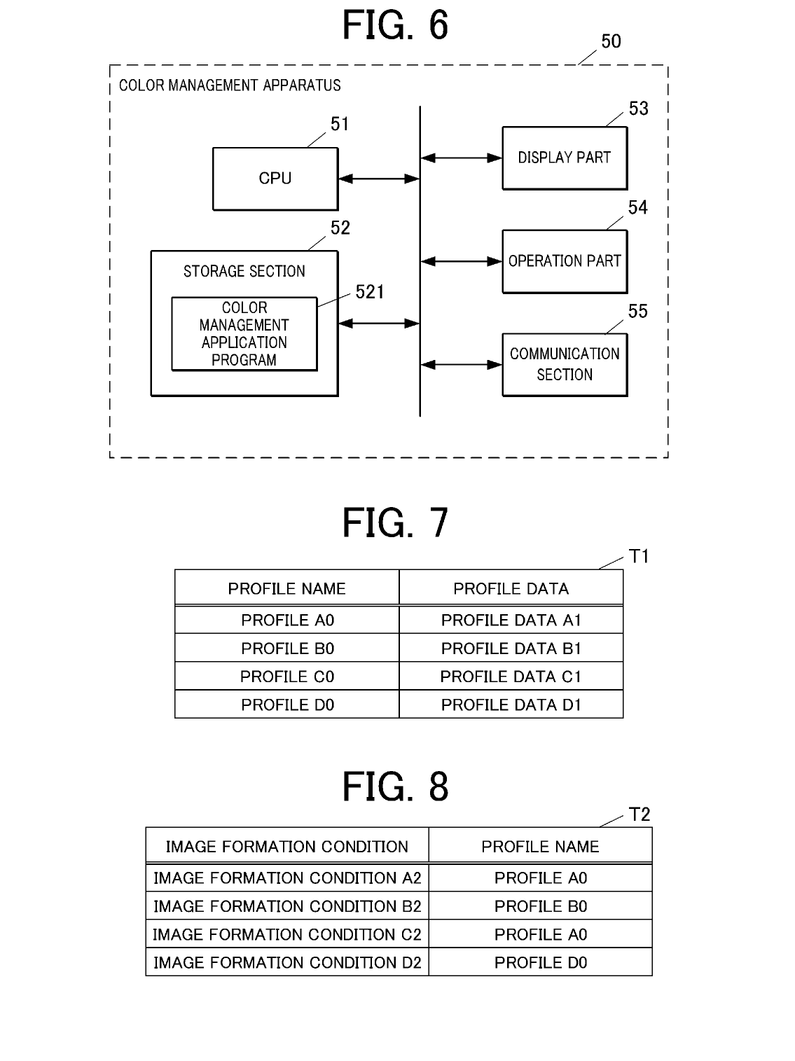

A color management application program 521 (see FIG. 6) for performing color management of the image forming apparatus 30 is installed in the color management apparatus 50. The color management apparatus 50 performs color verification, color adjustment, an execution instruction of color matching based on a color sample, data analysis, history management, and the like in the image forming apparatus 30.

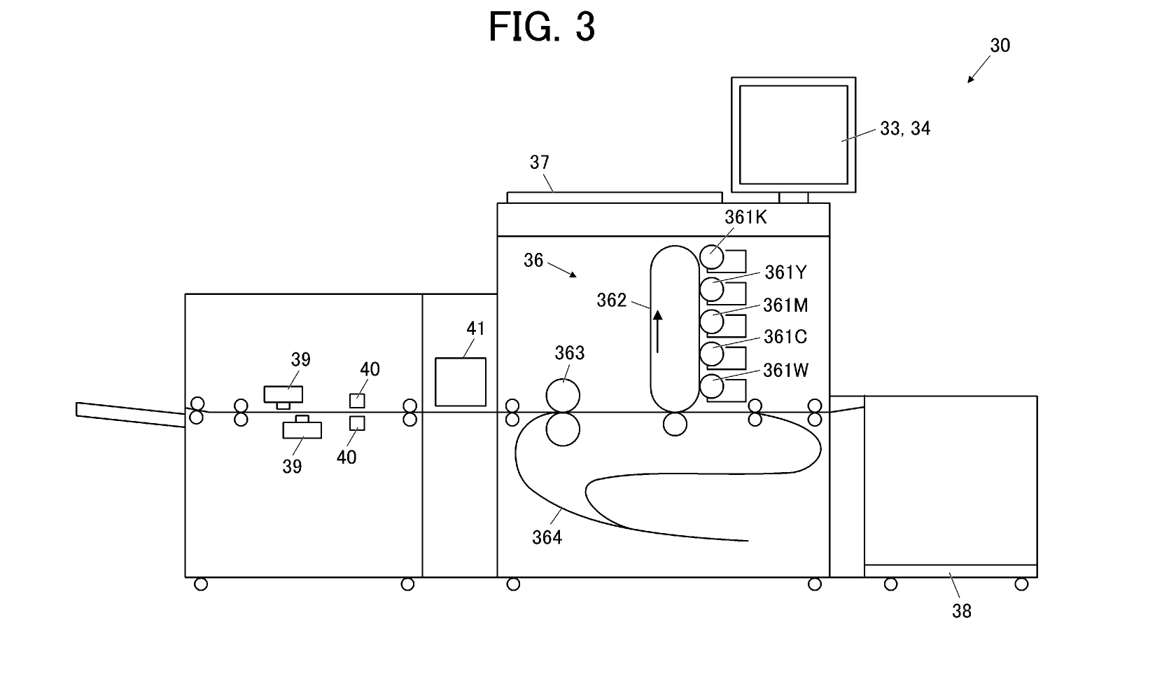

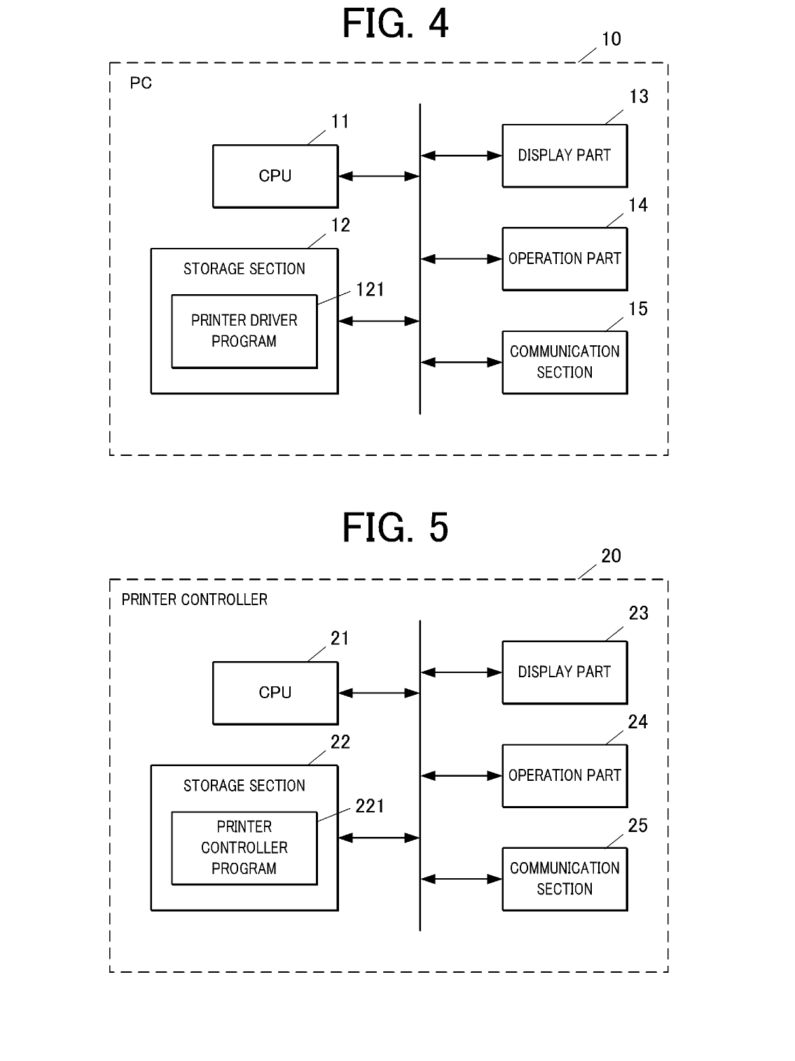

FIG. 2 shows a hardware configuration of the image forming apparatus 30. FIG. 3 illustrates an external configuration of the image forming apparatus 30. The image forming apparatus 30 is capable of image formation with toner in white (W), which is a special color, in addition to toner in four colors of cyan (C), magenta (M), yellow (Y), and black (K).

The image forming apparatus 30 includes a central processing unit (CPU) 31, a storage section 32, a display part 33, an operation part 34, a communication section 35, an image forming section 36, a platen scanner 37, a sheet feed section 38, an inline scanner 39, a colorimeter 40, and a decoration forming section 41.

The CPU 31 comprehensively controls processing operation of each section of the image forming apparatus 30. The CPU 31 reads various processing programs stored in the storage section 32 and performs various kinds of processing in cooperation with the programs.

The storage section 32 includes a hard disk drive (HDD), a solid state drive (SSD), and a non-volatile memory. The storage section 32 stores various processing programs, data related to various types of processing, and the like. For example, the storage section 32 stores sheet information and the like related to the image forming apparatus 30. Furthermore, the storage section 32 stores a target profile, a printer profile, a scanner profile, and the like.

The display part 33 is composed of a liquid crystal display (LCD). The display part 33 displays various screens according to an instruction of a display signal input from the CPU 31.

The operation part 34 accepts various kinds of operation by an operator, and outputs an operation signal based on the operation to the CPU 31. The operation part 34 includes a touch screen, a numeric keypad, a start button, a stop button, and the like.

The communication section 35 performs data communication with an external device. For example, the communication section 35 receives raster data from the printer controller 20. The communication section 35 receives a print instruction of a chart, an instruction to read the chart, and the like from the color management apparatus 50.

The image forming section 36 forms the image on the sheet by an electrophotographic method. The image forming section 36 includes photosensitive drums 361C, 361M, 361Y, 361K, and 361W corresponding to the respective colors of cyan (C), magenta (M), yellow (Y), black (K), and white (W), an intermediate transfer belt 362, a fixing section 363, and a reversing section 364. The image forming section 36, for example, uniformly charges the photosensitive drum 361C corresponding to cyan and then scans and exposes the photosensitive drum 361C with a laser beam based on image data of cyan to form an electrostatic latent image. The image forming section 36 makes cyan toner adhere to the electrostatic latent image on the photosensitive drum 361C to develop the image. Processing for the other colors is similar to the processing for cyan. The image forming section 36 sequentially transfers the toner images of the respective colors formed on the photosensitive drums 361C, 361M, 361Y, 361K, and 361W corresponding to the respective colors onto the intermediate transfer belt 362 (primary transfer). That is, a color toner image in which toner images of a plurality of colors are superimposed is formed on the intermediate transfer belt 362. The image forming section 36 collectively transfers the color toner image on the intermediate transfer belt 362 onto a sheet (secondary transfer). The fixing section 363 fixes the color toner image on the sheet by applying heat and pressure. In a case of performing image formation on both sides of the sheet, the reversing section 364 reverses the front and back of the sheet on which the image on the surface is fixed, and conveys the sheet again to the image formation section 36. The CPU 31 controls the image forming section 36 to form the image based on the image data.

FIG. 3 illustrates an example of the image forming section 36 that performs image formation using toner of five colors (CMYKW) of cyan, magenta, yellow, black, and white. Alternatively, the toner used in the image forming section 36 may not include white, or may include a special color other than white.

The scanner 37 reads a sheet placed on a document plate, a color sample, or the like, and generates read data having pixel values of respective colors of red (R), green (G), and blue (B).

The sheet feed section 38 includes a plurality of sheet feed trays, and feeds sheets stored in each sheet feed tray to the image forming section 36.

The inline scanner 39 is provided on a conveyance route on a downstream side of the image forming section 36 in a sheet conveyance direction. The inline scanner 39 is capable of reading the entire sheet in a sheet width direction orthogonal to the sheet conveyance direction. The inline scanner 39 reads a conveyed sheet and generates read data having pixel values of respective colors of red (R), green (G), and blue (B). The inline scanner 39 is, for example, a line type CCD sensor.

The colorimeter 40 is provided on a conveyance route downstream of the image forming section 36 in the sheet conveyance direction. The colorimeter 40 is a spectrophotometer and outputs a colorimetric value (L^{*}a^{*}b^{*} value, XYZ-value, etc.). The colorimeter 40 is configured to be movable in a sheet width direction. For example, the colorimeter 40 is used for calibration of the inline scanner 39 (creation of the scanner profile).

The decoration forming section 41 applies decoration processing to the sheet using a decoration material. For example, the decoration forming section 41 is a coating image forming section. In this case, the decoration forming section 41 includes a function of applying clear varnish to the sheet based on decoration image data. The clear varnish is a coating agent having translucency and is UV-curability varnish. The decoration forming section 41 coats an image (sheet) by applying varnish to the sheet and irradiating the varnish with ultraviolet rays (UV) to cure the varnish. Examples of the decoration processing include, in addition to clear varnish, foil stamping, and formation of a glossy layer with metal varnish. Foil stamping is a decorating process of pressing a resin film on which a metal layer has been vapor-deposited in advance against a sheet to be processed and transferring a foil (metal layer) to an arbitrary place on the sheet. The decoration image data is included in image data (raster data or the like) related to image formation. The decoration image data includes, for each pixel, information indicating whether or not to perform decoration processing.

FIG. 4 illustrates hardware configuration of the PC 10. The PC 10 includes a CPU 11, a storage section 12, a display part 13, an operation part 14, and a communication section 15.

The CPU 11 comprehensively controls a processing operation of each part of the PC 10. The CPU 11 reads various processing programs stored in the storage section 12, and performs various kinds of processing in cooperation with the programs.

The storage section 12 includes an HDD, an SSD, a non-volatile memory, and the like. The storage section 12 stores various processing programs such as a printer driver program 121, data related to various processes, and the like.

The display part 13 is configured by an LCD. The display part 13 displays various screens according to an instruction of a display signal input from the CPU 11.

The operation part 14 includes a keyboard and a pointing device such as a mouse. The operation part 14 outputs, to the CPU 11, operation signals input by key operation on the keyboard and operation on the pointing devices.

The communication section 15 performs data communication with an external device.

FIG. 5 shows a hardware configuration of the printer controller 20. The printer controller 20 includes a CPU 21, a storage section 22, a display part 23, an operation part 24, and a communication section 25. Since each unit in the printer controller 20 is the same as each unit in the PC 10, a part different from the PC 10 will be described.

A printer controller program 221 is stored in the storage section 22. A target profile, a printer profile, and the like are stored in the storage section 22.

FIG. 6 shows a hardware configuration of the color management apparatus 50. The color management apparatus 50 includes a CPU 51, a storage section 52, a display part 53, an operation part 54, and a communication section 55. Since each unit in the color management apparatus 50 is the same as each unit in the color management apparatus PC 10, the parts different from the color management apparatus PC 10 will be described.

The storage section 52 stores a color management application program 521. A color management application is implemented by cooperation between the CPU 51 and a color management application program 521. The color management application provides a user interface for giving an instruction to perform color management of the image forming apparatus 30, confirming a color verification result, calculating a correction value, and the like. Note that the method of using the color management application is not limited to the case where the program is locally installed. Alternatively, a color management application on a cloud may be used from the color management apparatus 50 via a browser in the form of a SaaS (Software as a Service) type service.

In the first embodiment, a case where the PC 10 (printer driver) is the print job management apparatus according to the present disclosure will be described.

Furthermore, in the first embodiment, inspection of a print job will be described as an operation mode in which the inline scanner 39 is used in the image forming apparatus 30.

The inspection of the print job is processing of printing an image such as an illustration or a natural image in the image forming apparatus 30 and examining whether or not the printing is performed as intended. For example, the inspection of the print job includes the determination of whether or not the color of the printed material is a target color, and whether or not there is a misregistration, a defect in the image, or a stain and the like.

In the inspection of the print job, a spot color (special color) or an alternative color in the printed material may be set as an inspection target.

The spot color is specified by the color of dedicated toner, dedicated ink, or the like on the image data (document data). The spot color is a color for which high color reproducibility is required. Examples of the spot color include a corporate color and a color of a logo mark. When a spot color is specified on the image data, the spot color is replaced with an approximate color that is a combination of process colors (CMYK value). The inspection of the spot color includes, for example, determining whether a color difference between a color printed with an approximate color (CMYK value) and the color of the spot color is an allowable value or less.

The alternative color is a color that is replaced in the function of replacing a set arbitrary color with a specified color. The inspection of the alternative color includes determination of whether or not the color printed with the replaced color (CMYK value) is a target color (specified color).

The CPU 11 (controller, hardware processor) of the PC 10 manages a print job to be executed by the image forming section 36 (image forming engine) of the image forming apparatus 30. The CPU 11 sets the scanner profile in association with the image formation conditions under which the image formation of the printed material is performed. "Setting the scanner profile in association with the image formation condition" may be storing the information indicating a correspondence relationship between the image formation condition and the scanner profile, or may be notifying another apparatus of the information indicating the correspondence relationship between the image formation condition and the scanner profile.

The storage section 12 of the PC 10 stores correspondence tables T1 and T2.

FIG. 7 shows an example of a data structure in the correspondence table T1. In the correspondence table T1, profile names and profile datasets are associated with each other in advance. The profile name is the name of the scanner profile. The profile data is data of the scanner profile. The profile datasets A1 to D1 may be stored in advance as individual datasets in the storage section 12 (correspondence table T1). Alternatively, for example, only the profile data A1 may be registered in the storage section 12, and the profile data B1 to D1 may be generated on the basis of the profile data A1. In that case, it is conceivable to generate the profile data using the generative AI.

FIG. 8 shows an example of the data structure in the correspondence table T2. In the correspondence table T2, image formation conditions and profile names are associated with each other in advance. The image formation conditions include the color (CMYK, K, CMYKW, W, or the like) of the toner used for image formation, the presence or absence of decoration processing (clear varnish, foil stamping, metal varnish, or the like), single-sided/double-sided printing, and the like. The image formation conditions and the scanner profiles are not necessarily in a one to-one correspondence, and it is also possible to associate the same scanner profile with different image formation conditions. In the example of FIG. 8, the same profile A0 is associated with the image formation condition A2 and the image formation condition C2. The image formation condition and the profile data may be associated with each other via the profile name, or the profile data may be directly associated with the image formation condition.

The CPU 11 manages a plurality of scanner profiles in association with the image formation conditions.

The CPU 11 acquires the information on a first scanner profile for converting read data of the printed material of which the image formation is performed under a first image formation condition. Based on the acquired information on the first scanner profile, the CPU 11 sets the first scanner profile in association with the first image formation condition.

The CPU 11 acquires the information on a second scanner profile for converting the read data of the printed material of which the image formation is performed under the second image formation condition. Based on the acquired information on the second scanner profile, the CPU 11 sets the second scanner profile in association with the second image formation condition.

For example, the first image formation condition is the image formation condition including color materials other than the four color materials (CMYK toners) of cyan, magenta, yellow, and black.

The second image formation condition is the image formation condition that does not include the color material other than the four color materials of cyan, magenta, yellow, and black.

The color material other than the four color materials (CMYK toner) may be a white color material (white toner) in the same image forming method as the four color materials. In this case, the CPU 11 sets a scanner profile suitable for each image formation condition depending on whether it is the image formation condition including the white toner (special color) or the image formation condition not including the white toner.

In addition, the color material other than the four color materials (CMYK toners) may be the decoration material (clear varnish, foil stamping, metal varnish, or the like). In this case, the CPU 11 sets a scanner profile suitable for each image formation condition depending on whether it is the image formation condition including the decoration material or the image formation condition not including the decoration material.

In a case where a single printed material includes a plurality of regions having different image formation conditions, the CPU 11 switches between the first scanner profile and the second scanner profile in accordance with the region on the single printed material. Here, the single printed material is one sheet (the same page) on which the image formation is performed.

For example, the CPU 11 switches between the first scanner profile and the second scanner profile in a direction (sheet width direction or main scanning direction) orthogonal to a direction in which a single printed material is conveyed when the single printed material is read.

The CPU 11 switches between the first scanner profile and the second scanner profile in a direction (sheet conveyance direction or sub-scanning direction) in which the single printed material is conveyed when the single printed material is read.

In a case where the image formation condition may be different for each page included in a print job to be processed, the CPU 11 switches between the first scanner profile and the second scanner profile for each page.

In a case where the image formation condition may be different for each print job to be processed, the CPU 11 switches between the first scanner profile and the second scanner profile according to the print job to be processed.

The CPU 11 switches between the first scanner profile and the second scanner profile based on the print data corresponding to the print job to be processed. The print data includes the image data of an image formation target, the image formation condition, and the like. The CPU 11 sets a scanner profile based on the contents of the image formation condition included in the print data. The CPU 11 switches the scanner profile for each print job, each page, and each region on the basis of the print data.

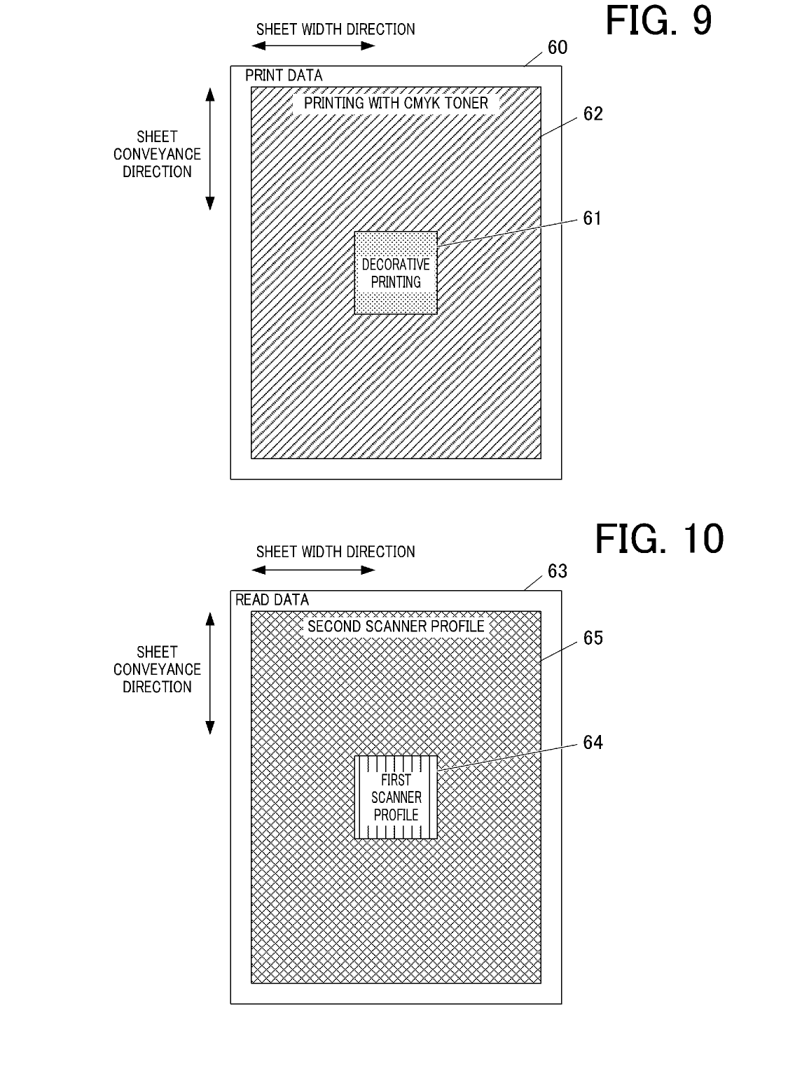

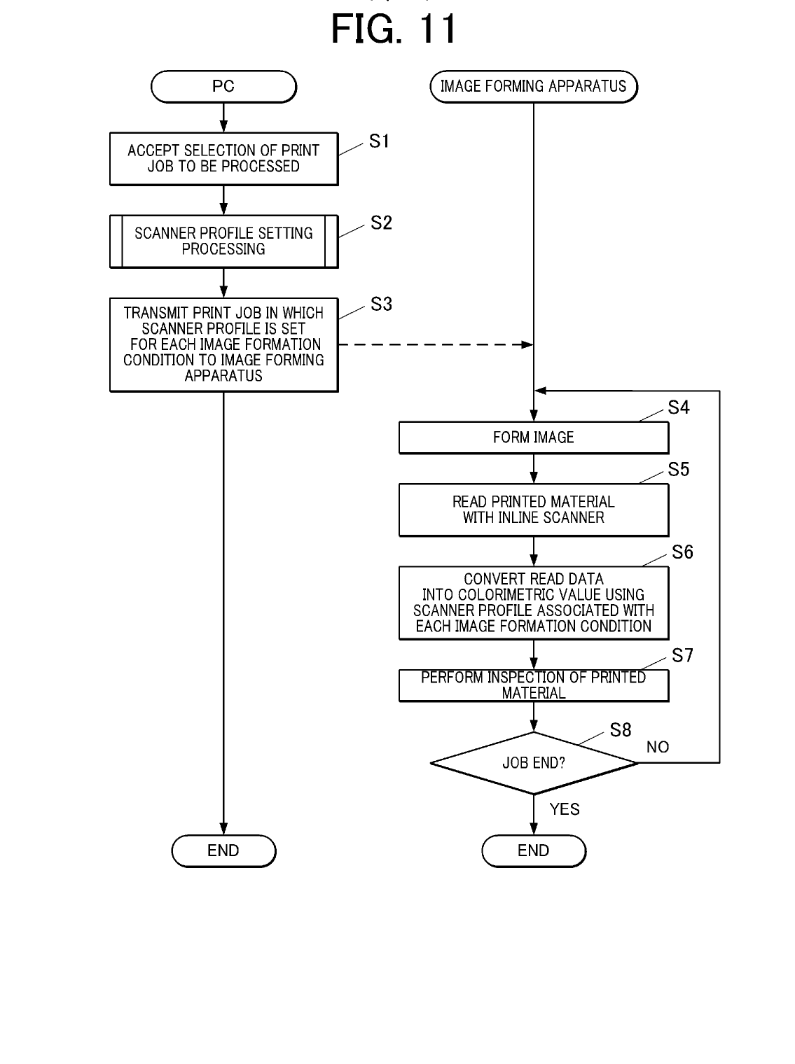

FIG. 9 shows an example in which different image formation conditions are set in respective regions 61 and 62 constituting the print data 60. The region 61 is the region on which decorative printing is performed by the decoration forming section 41 of the image forming apparatus 30. The region 62 is the region in which printing with the CMYK toner is performed in the image forming section 36 of the image forming apparatus 30. The sheet width direction illustrated in FIG. 9 corresponds to the main scanning direction in which the printed material of which the image formation is performed based on the print data 60 is read by the inline scanner 39. The sheet conveyance direction illustrated in FIG. 9 corresponds to the sub-scanning direction when the printed material of which the image formation is performed based on the print data 60 is read by the inline scanner 39. The same applies to the sheet width direction and the sheet conveyance direction illustrated in FIG. 10.

FIG. 10 illustrates the example of read data 63 generated by reading the printed material of which the image formation is already performed on the basis of the print data 60. The first scanner profile corresponding to the image formation condition for decorative printing is applied to a region 64 of read data 63. The second scanner profile corresponding to the image formation condition for the CMYK printing is applied to a region 65 of the read data 63.

Next, the operation of the color management system 100 according to the first embodiment will be described.

FIG. 11 is a ladder chart illustrating inspection processing executed in the PC 10 and the image forming apparatus 30.

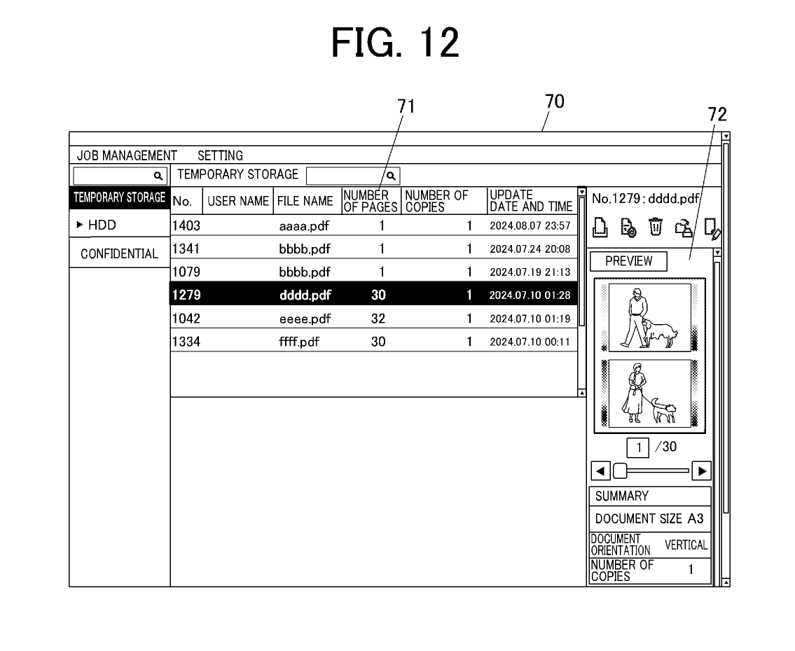

First, in the PC 10, the CPU 11 accepts selection of the print job to be processed (step S1). For example, the CPU 11 causes the display part 13 to display a job management screen 70 illustrated in FIG. 12. The job management screen 70 includes a job list field 71, a preview field 72, and the like.

A job list field 71 shows a list of print jobs managed in the color management system 100.

In the preview field 72, a preview image related to the print job selected in the job list field 71 is displayed.

When the operator selects a print job from the job list field 71 by an operation on the operation part 14, the CPU 11 causes a preview image related to the selected print job to be displayed in the preview field 72.

Next, the CPU 11 executes scanner profile setting processing (step S2).

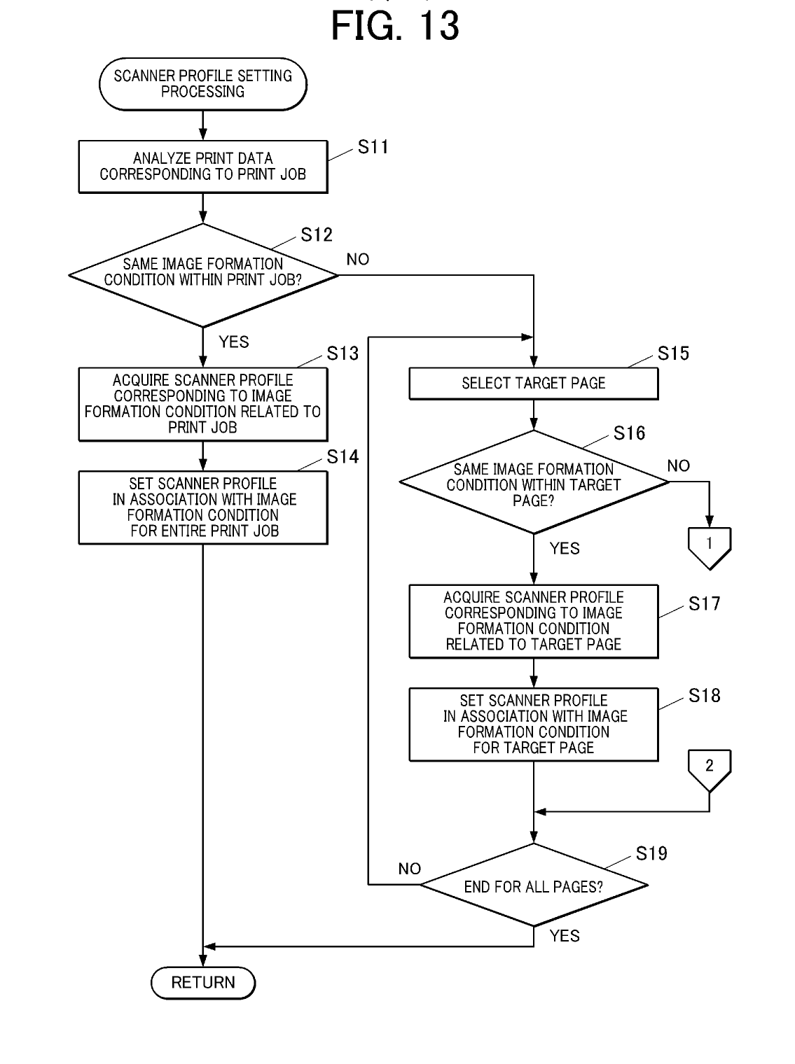

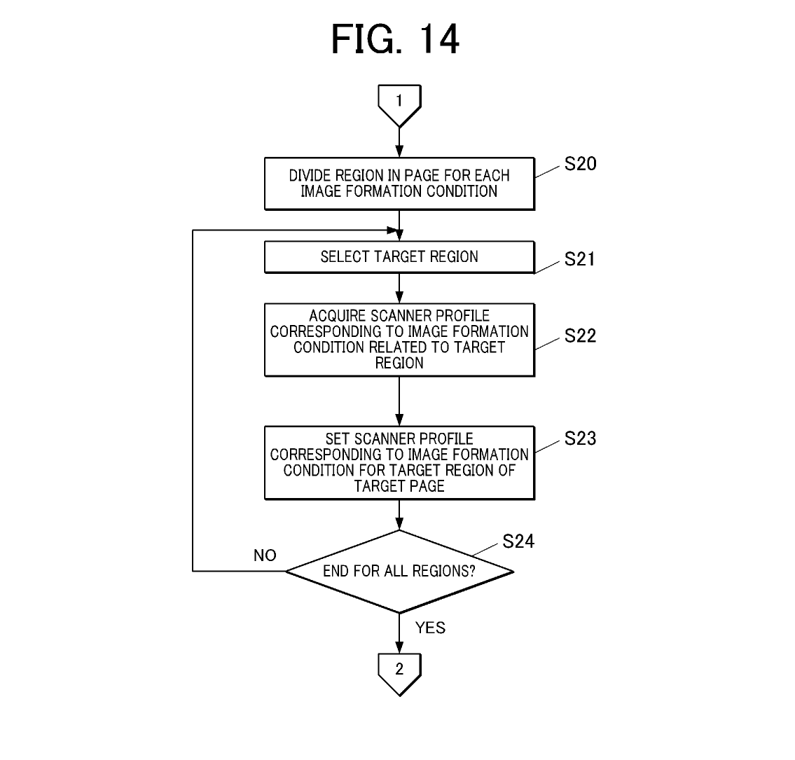

Here, the scanner profile setting processing will be described with reference to FIG. 13 and FIG. 14.

First, the CPU 11 analyzes the print data corresponding to the print job (step S11). To be specific, the CPU 11 acquires the image formation condition related to image formation in the image forming apparatus 30 from the print data. For example, the CPU 11 determines whether it is the image formation condition including the white toner or the image formation condition not including the white toner based on the print data. In addition, the CPU 11 may distinguish the image formation condition depending on whether it is the image formation condition including only the K toner or it is the image formation condition including only the white toner. Further, the CPU 11 determines whether it is the image formation condition including the decoration material or the image formation condition not including the decoration material. The CPU 11 analyzes the print data to acquire the information on which image formation condition is used for which region (coordinate) in the printed material of which the image formation is performed.

In the first embodiment, the print job in step S11 is the job for image formation of the printed material to be inspected.

Next, the CPU 11 determines whether or not the image formation conditions in the print job are the same (step S12). The CPU 11 determines whether or not the image formation conditions are common in the entire print job.

When the image formation conditions in the print job are the same (step S12; YES), the CPU 11 acquires a scanner profile corresponding to the image formation conditions related to the print job (step S13). To be specific, the CPU 11 acquires the profile name corresponding to the image formation condition related to the print job with reference to the correspondence table T2. In addition, the CPU 11 may further refer to the correspondence table T1 to obtain profile data corresponding to the profile name.

Next, the CPU 11 sets the acquired scanner profile in association with the image formation condition for the entire print job (step S14). For example, the CPU 11 causes the storage section 12 to store information indicating a correspondence relationship among a print job, image formation condition, and identification information (profile name or the like) of the scanner profile. The CPU 11 sets the scanner profile corresponding to the image formation condition for the entire print job.

If the image formation conditions in the print job are not the same in step S12 (step S12; NO), the CPU 11 selects a page to be processed (target page) from the print data (step S15).

Next, the CPU 11 determines whether or not the image formation conditions within the target page are the same (step S16). The CPU 11 determines whether or not the image formation condition is common in the entire target page.

In a case where the image formation conditions within the target page are the same (step S16; YES), the CPU 11 acquires the scanner profile corresponding to the image formation conditions related to the target page (step S17). To be specific, the CPU 11 refers to the correspondence table T2 and acquires the profile name corresponding to the image formation condition related to the target page. In addition, the CPU 11 may further refer to the correspondence table T1 to obtain the profile data corresponding to the profile name.

Next, the CPU 11 sets the acquired scanner profile in association with the image formation condition for the target page (step S18). For example, the CPU 11 causes the storage section 12 to store the information indicating the correspondence relationship among the target page of the print job, the image formation condition, and the identification information (profile name or the like) of the scanner profile. The CPU 11 sets a scanner profile corresponding to the image formation condition for the target page.

In step S16, when the image formation conditions in the target page are not the same (step S16; NO), the process proceeds to step S20 of FIG. 14. In step S20, the CPU 11 divides the target page into regions in the page for each image formation condition.

Next, the CPU 11 selects the region to be processed (target region) from among the plurality of divided regions (step S21).

Next, the CPU 11 acquires a scanner profile corresponding to the image formation condition related to the target region (step S22). To be specific, the CPU 11 refers to the correspondence table T2 and acquires the profile name corresponding to the image formation condition related to the target region. In addition, the CPU 11 may further refer to the correspondence table T1 to obtain the profile data corresponding to the profile name.

Next, the CPU 11 sets the acquired scanner profile in association with the image formation condition for the target region of the target page (step S23). For example, the CPU 11 causes the storage section 12 to store the information indicating the correspondence relationship among the target region (coordinates) of the target page, the image formation conditions, and the identification information (profile name or the like) of the scanner profile. The CPU 11 sets the scanner profile corresponding to the image formation conditions for the target region of the target page.

Next, the CPU 11 determines whether the processing has been completed for all the regions among the plurality of regions divided in step S20 (step S24).

When there is the region for which the process has not been completed (step S24; NO), the process returns to step S21. The CPU 11 selects another region as the target region, and repeats the processing of step S21 to step S24.

When the processing has been completed for all the regions in step S24 (step S24; YES), or after step S18 in FIG. 13, the processing proceeds to step S19. In step S19, the CPU 11 determines whether the processing has been completed for all the pages.

When there is a page for which the processing is not completed (step S19; NO), the processing returns to step S15. The CPU 11 selects another page as the target page, and repeats the processing of step S15 and subsequent steps.

After step S14 or in step S19, when the processing is completed for all the pages (step S19; YES), the scanner profile setting processing ends.

As described above, in the scanner profile setting processing, the CPU 11 sets, for each of the image formation conditions, the scanner profile in association with the image formation condition for the print job (job to be inspected) selected in step S1.

Returning to FIG. 11, the CPU 11 in the PC 10 transmits the print job in which the scanner profile is set for each of the image formation conditions to the image forming apparatus 30 via the communication section 15 (step S3). The RIP processing and the like related to the print job is performed in the printer controller 20. To be specific, the CPU 11 in the PC 10 transmits the print job in which the scanner profile is set for each image formation condition to the printer controller 20 via the communication section 15. The CPU 21 of the printer controller 20 performs the RIP processing and the like on the print instruction data related to the print job, and transmits the processed image data (raster data) to the image forming apparatus 30 via the communication section 25.

The CPU 31 of the image forming apparatus 30 acquires, from the PC 10 via the communication section 35, the print job in which the scanner profile is set for each image formation condition. The CPU 31 may acquire, via the printer controller 20, the print job in which the scanner profile is set for each image formation condition. The CPU 31 causes the storage section 32 to store the information that indicates the correspondence relationship between the image formation condition and the scanner profile, the correspondence relationship being set for the entire print job, on a page-by-page basis (unit of pages), and for each region in the page. Based on the raster data related to the print job, the CPU 31 controls the image forming section 36 to form the image on the sheet (step S4). The CPU 31 also controls the decoration forming section 41 as necessary to form the decoration on the sheet. In step S4, the CPU 31 creates the printed material for one sheet.

Next, the CPU 31 controls the inline scanner 39 to read the printed material of which the image formation has been performed (step S5). The CPU 31 acquires read data (RGB value) of the printed material from the inline scanner 39.

Next, the CPU 31 converts the read data (RGB value) of the printed material into the colorimetric value (L^{*}a^{*}b^{*} value) by using the scanner profile associated with each image formation condition related to the image formation of the printed material (step S6). Hereinafter, a case where the L^{*}a^{*}b^{*} value is used as the colorimetric value will be described as an example but the XYZ value, etc. may also be used. The storage section 32 stores the scanner profile that can be set in the PC 10. For example, the CPU 31 specifies the scanner profile to be used from among the scanner profiles stored in the storage section 32, based on the identification information (profile name or the like) of the scanner profile associated with each image formation condition.

If the scanner profile has been set for the entire print job in association with the same image formation condition, the CPU 31 applies the scanner profile corresponding to the image formation condition to the entire read data of the printed material associated with the print job.

In a case where the scanner profile is set in association with the same image formation condition on a page-by-page basis, the CPU 31 applies on the read data of each page the scanner profile corresponding to the image formation condition related to each page.

In a case where the scanner profile is set for each region in the page in association with each image formation condition, the CPU 31 applies, for each region of the read data of the printed material, the scanner profile corresponding to the image formation condition related to the region.

Next, the CPU 31 performs the inspection of the printed material on the basis of the read data converted into the colorimetric value (step S7). For example, the CPU 31 determines whether the image formation has been correctly performed by comparing the read data (colorimetric value) of the printed material with reference image data. The reference image data may be document data to be used for image formation, or may be data obtained by converting the read data of the printed material of which the image formation has been correctly performed into the colorimetric value. When the CPU 31 determines that the printed material is not the intended printed material in the inspection of the printed material, the user discharges the printed material to be inspected as waste sheet to a tray different from a normal discharge destination.

Here, the CPU 31 determines whether or not the job has been completed (step S8). When the job is not completed (step S8; NO), the process returns to step S4. Note that the processing in step S4 to step S7 may overlap timewise with the processing in the step before and/or after the step among the step S4 to step S7 being processed.

In step S8, when the job is completed (step S8; YES), the inspection processing ends.

According to the first embodiment, the CPU 11 of the PC 10 sets the scanner profile in association with image formation conditions under which the image formation of the printed material is performed. Thus, the CPU 31 of the image forming apparatus 30 can apply the scanner profile suitable for the image formation condition to the read data of the printed material of which the image formation is performed under each image formation condition. Therefore, the color management system 100 can use the scanner profile suitable for each image formation condition.

For example, the CPU 11 sets the scanner profile suitable for each image formation condition depending on whether it is the image formation condition including the white toner other than the CMYK toner or the image formation condition not including the white toner. In a case of using the special color toner such as the white toner, there has been a risk that reading accuracy by the inline scanner 39 decreases with the same scanner profile as in a case of using only the CMYK toner. In contrast, according to the first embodiment, it is possible to suppress the decrease in the reading accuracy of the inline scanner 39.

In addition, the CPU 11 sets the scanner profile suitable for each image formation condition depending on whether it is the image formation condition including the decoration material or the image formation condition not including the decoration material. In a case where the decoration material is used, the reading accuracy by the inline scanner 39 may deteriorate with the same scanner profile as that in a case where only the CMYK toner is used. In contrast, according to the first embodiment, it is possible to suppress the decrease in the reading accuracy of the inline scanner 39.

In addition, when the plurality of regions having different image formation conditions are included in the single printed material, the CPU 11 can switch the scanner profile according to the region on the single printed material. The CPU 11 can switch the scanner profile in the sheet width direction or the sheet conveyance direction when reading the printed material. Thus, the CPU 31 of the image forming apparatus 30 can perform color conversion into the colorimetric value with high accuracy.

In a case where the plurality of pages are included in the print job to be processed, special printing (special color toner, foil stamping, or the like) or color paper may be used for a cover sheet, a frontispiece, and a cover art. In this case, if the same scanner profile is used for all the pages, there is a risk that the page with poor reading accuracy by the inline scanner 39 may be generated.

According to the first embodiment, in a case where the image formation conditions can be different for each page included in the print job to be processed, the CPU 11 can switch the scanner profile for each page.

In addition, in a case where the image formation conditions can be different for each print job to be processed, the CPU 11 can switch the scanner profile according to the print job to be processed.

Furthermore, the CPU 11 can accurately acquire the image formation condition from the print data corresponding to the print job to be processed. Thus, the color management system 100 can use the scanner profile suitable for each image formation condition.

In particular, in the first embodiment, the CPU 11 of the PC 10 can set the scanner profile in association with each image formation condition used in the print job to be inspected.

Note that on the image forming apparatus 30 side, the CPU 31 may acquire the information on the scanner profile for converting the read data of the printed material of which the image formation is performed under each image formation condition, and based on the acquired information on the scanner profile, set the scanner profile in association with the image formation condition.

Furthermore, the CPU 31 of the image forming apparatus 30 may set the scanner profile on the basis of the image formation conditions when the image formation of the printed material is actually performed. Further, the CPU 31 may convert the read data of the printed material by using the scanner profile corresponding to the image formation condition when the image formation of the printed material is actually performed.

### Second Embodiment

Next, a second embodiment to which the present disclosure is applied will be described.

Since the color management system according to the second embodiment has the same configuration as the color management system 100 according to the first embodiment, the same constituent elements as those according to the first embodiment are denoted by the same reference signs, and description thereof is omitted. Hereinafter, characteristic configurations and processes of the second embodiment will be described.

In the second embodiment, a case where the color management apparatus 50 is the print job management apparatus according to the present disclosure will be described.

In the second embodiment, creation of a color parameter of the image forming apparatus 30 will be described as an operation mode in which the inline scanner 39 is used in the image forming apparatus 30.

The CPU 51 (controller or hardware processor) of the color management apparatus 50 manages the print job to be executed by the image forming section 36 (image forming engine) of the image forming apparatus 30. The CPU 51 sets the scanner profile in association with the image formation conditions under which the image formation of the printed material is performed.

The image forming section 36 of the image forming apparatus 30 prints a predetermined color parameter creation chart (patch). The inline scanner 39 of the image forming apparatus 30 reads the color parameter creation chart (printed material) and generates the read data.

The CPU 51 of the color management apparatus 50 creates the color parameter of the image forming apparatus 30 based on the read data of the color parameter creation chart. The color parameters include an ICC profile, a maximum density setting, a one dimensional table, a density balance table, and the like.

The ICC profile is the profile conforming to the ICC standard, and is a series of data indicating color characteristics of an input/output device relating to color. Here, the CPU 51 creates, as the ICC profile, a printer profile, a device-link profile, and the like of the image forming apparatus 30.

The maximum density setting is setting information for adjusting the maximum density for each of the CMYKW colors.

The one dimensional table is a table indicating a correspondence relationship between an input and an output for each color of CMYKW, a tone curve, or the like.

The density balance table is a correction table for suppressing in-plane unevenness for each of the CMYKW colors.

The correspondence tables T1 and T2 are stored in the storage section 52 of the color management apparatus 50. The correspondence tables T1 and T2 are the same as the correspondence tables T1 and T2 shown in FIGS. 7 and 8, respectively.

The CPU 51 manages the plurality of scanner profiles in association with the image formation conditions.

The CPU 51 acquires the information on the first scanner profile for converting the read data of the printed material of which the image formation is performed under the first image formation condition. Based on the acquired information on the first scanner profile, the CPU 51 sets the first scanner profile in association with the first image formation condition.

The CPU 51 acquires the information on the second scanner profile for converting the read data of the printed material of which the image formation is performed under the second image formation condition. The CPU 51 sets the second scanner profile in association with the second image formation condition on the basis of the acquired information on the second scanner profile.

For example, the first image formation condition is the image formation condition including color materials other than the four color materials (CMYK toners) of cyan, magenta, yellow, and black.

The second image formation condition is the image formation condition that does not include the color material other than the four color materials of cyan, magenta, yellow, and black.

The color material other than the four color materials (CMYK toner) may be a white color material (white toner) in the same image forming method as the four color materials. In this case, the CPU 51 sets the scanner profile suitable for each image formation condition depending on whether it is the image formation condition including the white toner (special color) or the image formation condition not including the white toner.

In addition, the color material other than the four color materials (CMYK toners) may be the decoration material (clear varnish, foil stamping, metal varnish, or the like). In this case, the CPU 51 sets the scanner profile suitable for each image formation condition depending on whether it is the image formation condition including the decoration material or the image formation condition not including the decoration material.

In a case where the single printed material includes the plurality of regions having different image formation conditions, the CPU 51 switches between the first scanner profile and the second scanner profile in accordance with the region on the single printed material.

For example, the CPU 51 switches between the first scanner profile and the second scanner profile in the direction orthogonal to the direction in which the single printed material is conveyed when the single printed material is read.

The CPU 51 switches between the first scanner profile and the second scanner profile in the direction in which the single printed material is conveyed when the single printed material is read.

In a case where the image formation condition may be different for each page included in the print job to be processed, the CPU 51 switches between the first scanner profile and the second scanner profile for each page.

In a case where the image formation condition may be different for each print job to be processed, the CPU 51 switches between the first scanner profile and the second scanner profile according to the print job to be processed.

The CPU 51 switches between the first scanner profile and the second scanner profile based on the print data corresponding to the print job to be processed. The CPU 51 sets the scanner profile based on the contents of the image formation condition included in the print data. The CPU 51 changes the scanner profile for each print job, each page, and each region on the basis of the print data.

Next, the operation of the color management system 100 according to the second embodiment will be described.

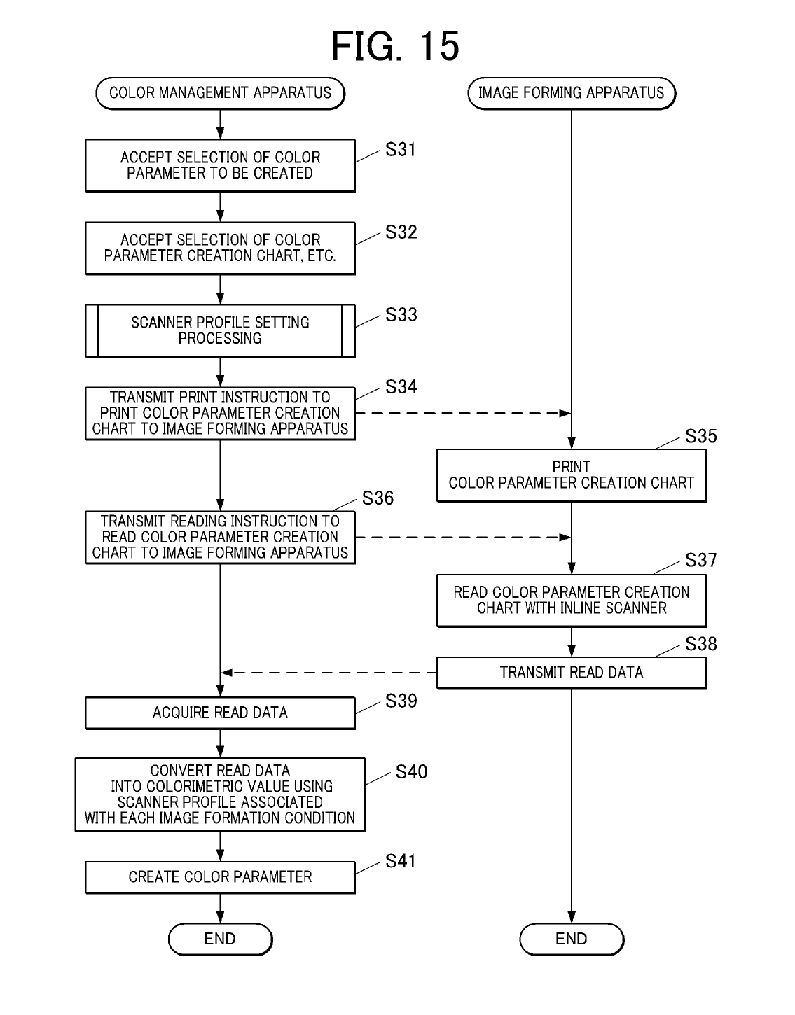

FIG. 15 is a ladder chart illustrating color parameter creation processing executed in the color management apparatus 50 and the image forming apparatus 30.

First, in the color management apparatus 50, the CPU 51 accepts a selection of a color parameter to be created (step S31). For example, the CPU 51 causes the display part 53 to display a plurality of types of color parameters. The operator selects one of the color parameters by an operation on the operation part 54.

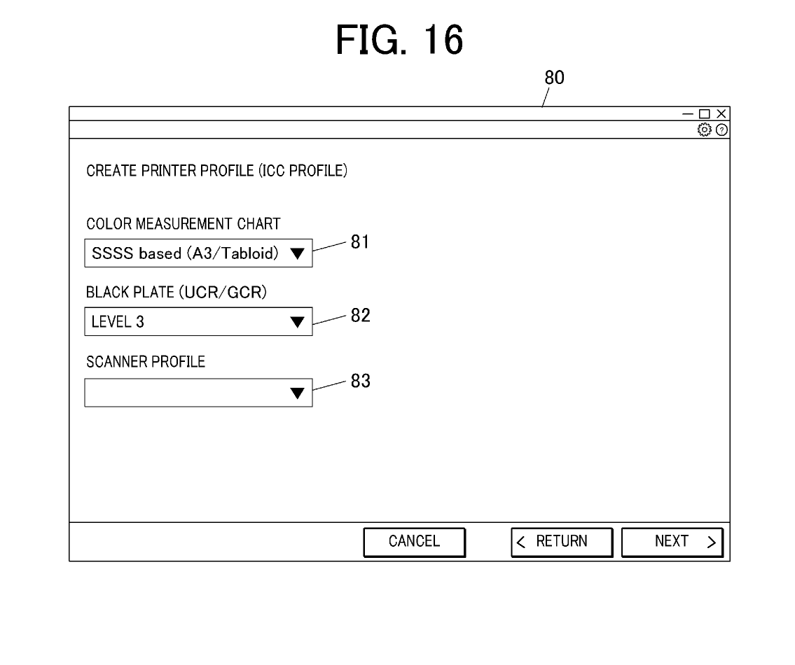

Next, the CPU 51 receives selection of a color parameter creation chart or the like (step S32). For example, as illustrated in FIG. 16, the CPU 51 allows the display part 53 to display a color parameter creation screen 80 for a color parameter to be created. The color parameter creation screen 80 includes a color measurement chart selection field 81, a black plate level selection field 82, a scanner profile selection field 83, and the like.

The color measurement chart selection field 81 is a region for selecting a color measurement chart (color parameter creation chart). The operator selects one of the color measurement charts in the color measurement chart selection field 81 by an operation on the operation part 54.

The black plate level selection field 82 is the region for selecting a level for UCR/GCR. UCR (Under Color Removal) is to replace CMY in a shadow part with a black plate (K). GCR (Gray Component Replacement) is to replace CMY from a highlight part to a shadow part, that is, all gradation parts with a black plate (K). The operator selects one of the levels in the black plate level selection field 82 by an operation on the operation part 54.

The scanner profile selection field 83 is a region for selecting a scanner profile. When the operator desires to directly specify the scanner profile, the operator selects one of the scanner profiles in the scanner profile selection field 83 by an operation on the operation part 54.

Next, the CPU 51 executes scanner profile setting processing (step S33). The processing in step S33 is similar to the scanner profile setting processing (refer to FIG. 13 and FIG. 14) except that the subject of the operation is the CPU 51. Here, the job of printing the chart used for creating the color parameters selected in step

S31 is a "print job" in the scanner profile setting processing. The CPU 51 sets, for each image formation condition, the scanner profile in association with the image formation condition, for the print job of printing the color parameter creation chart. The CPU 51 causes the storage section 52 to store the information that indicates the correspondence relationship between the image formation condition and the scanner profile, the correspondence relationship being set for the entire print job, for each page, and for each region in the page.

Next, the CPU 51 transmits the print instruction of the chart (color parameter creation chart) to the image forming apparatus 30 via the communication section 55 (step S34). The print instruction of the chart may be transmitted from the color management apparatus 50 to the image forming apparatus 30 via the printer controller 20 as necessary.

The CPU 31 of the image forming apparatus 30 acquires the print instruction to print the chart from the color management apparatus 50 via the communication section 35. The CPU 31 controls the image forming section 36 on the basis of the print instruction for the chart to print the color parameter creation chart on the sheet (step S35). The color parameter creation chart may include a portion decorated and printed by the decoration forming section 41.

Next, the CPU 51 of the color management apparatus 50 transmits a reading instruction to read the chart (color parameter creation chart) to the image forming apparatus 30 via the communication section 55 (step S36).

The CPU 31 of the image forming apparatus 30 acquires a reading instruction to read the chart from the color management apparatus 50 via the communication section 35. The CPU 31 controls the inline scanner 39 to read the color parameter creation chart (printed material) (step S37). The CPU 31 acquires the read data (RGB value) of the chart from the inline scanner 39.

Next, the CPU 31 transmits the read data of the chart (color parameter creation chart) to the color management apparatus 50 via the communication section 35 (step S38).

The CPU 51 of the color management apparatus 50 acquires the read data of the chart from the image forming apparatus 30 via the communication section 55 (step S39).

Next, the CPU 51 converts the read data (RGB value) of the color parameter creation chart into the colorimetric value (L^{*}a^{*}b^{*} value) using the scanner profile associated with each of the image formation conditions related to the image formation of the color parameter creation chart (step S40). For example, the CPU 51 specifies the scanner profile to be used from among the scanner profiles stored in the storage section 52, based on the identification information (profile name or the like) of the scanner profile associated with each image formation condition.

In a case where a scanner profile is set for the entire color parameter creation chart in association with the same image formation condition, the CPU 51 applies the scanner profile corresponding to the image formation condition to the entire read data of the chart.

In a case where the scanner profile is set in association with the same image formation condition in a unit of each page of the color parameter creation chart, the CPU 51 applies the scanner profile corresponding to the image formation condition related to the page on the read data of each page.

In a case where the scanner profile is set in association with each image formation condition for each region of the single sheet of the color parameter creation chart, the CPU 51 applies, for each region of the read data of the single sheet of the chart, the scanner profile corresponding to the image formation condition related to the region.

Next, the CPU 51 creates the color parameter selected in step S31, based on the read data (colorimetric value) of the color parameter creation chart (step S41). A target value (L^{*}a ^{*}b^{*} value) is determined in advance for each patch included in the color parameter creation chart.

The CPU 51 creates the color parameter based on a difference between the read result (colorimetric value) and the target value in each patch. For example, the CPU 51 creates the printer profile, the device-link profile, and the like for the image forming apparatus 30. Further, the CPU 51 may create a maximum density setting, a one dimensional table, a density balance table, and the like for the image forming apparatus 30. The CPU 51 transmits the created color parameters to the image forming apparatus 30 via the communication section 55.

At the image forming apparatus 30, the CPU 31 causes the storage section 32 to store the color parameter.

Thus, the color parameter creation processing ends.

According to the second embodiment, the CPU 51 of the color management apparatus 50 sets the scanner profile in association with the image formation condition under which the image formation of the printed material is performed. Thus, the CPU 51 can apply the scanner profile suitable for the image formation condition to the read data of the printed material of which the image formation is performed under the image formation condition. Therefore, the CPU 51 can use the scanner profile suitable for each image formation condition.

For example, the CPU 51 sets the scanner profile suitable for each image formation condition depending on whether it is the image formation condition including the white toner other than the CMYK toners or the image formation condition not including the white toner. As a result, the CPU 51 can suppress the decrease in the reading accuracy of the inline scanner 39.

Furthermore, the CPU 51 sets the scanner profile suitable for each image formation condition depending on whether it is the image formation condition including the decoration materials or the image formation condition not including the decoration materials. As a result, the CPU 51 can suppress the decrease in the reading accuracy of the inline scanner 39.

In addition, when the plurality of regions having different image formation conditions are included in a single printed material, the CPU 51 can switch the scanner profile according to the region on the single printed material. The CPU 51 can switch the scanner profile in the sheet width direction or the sheet conveyance direction when reading the printed material. Thus, the CPU 51 can accurately perform the color conversion into the colorimetric value.

Further, in the case where the image formation conditions may be different for each page included in the print job to be processed, the CPU 51 can switch the scanner profile for each page.

In addition, in a case where the image formation conditions may be different for each print job to be processed, the CPU 51 can switch the scanner profile according to the print job to be processed.

Furthermore, the CPU 51 can accurately acquire the image formation condition from the print data corresponding to the print job to be processed. Thus, the CPU 51 can use the scanner profile suitable for each image formation condition.

In particular, in the second embodiment, the CPU 51 can set a scanner profile in association with each image formation condition used in printing of the color parameter creation chart.

Note that the description has been given of the case where, in the color parameter creation processing (see FIG. 15), the read data is converted into the colorimetric value on the color management apparatus 50 side in step S40. Alternatively, the image forming apparatus 30 side may convert the read data into the colorimetric value. In this case, after step S33 and before step S38, the CPU 51 of the color management apparatus 50 transmits, to the image forming apparatus 30 via the communication section 55, the information that indicates the correspondence relationship between the image formation conditions and the scanner profiles, the correspondence relationship being set for the entire print job, on a page-by-page basis, and for each region in the page. The information that indicates the correspondence relationship between the image formation conditions and the scanner profiles, the correspondence relationship being set for the entire print job, on a page-by-page basis, and for each region in the page is the information generated in step S33. Next, in step S38, the CPU 31 of the image forming apparatus 30 converts the read data into the colorimetric value using the scanner profile associated with the image formation condition, the scanner profile being set for the entire print job, on a page-by-page basis, and for each region in the page, and then transmits the colorimetric value to the color management apparatus 50 via the communication section 35. The CPU 51 of the color management apparatus 50 generates the color parameter based on the read data converted into the colorimetric value on the image forming apparatus 30 side.

In addition, the CPU 51 of the color management apparatus 50 may acquire the image formation condition when the image formation of the printed material (color parameter creation chart) is actually performed from the image forming apparatus 30. In this case, the CPU 51 sets the scanner profile on the basis of the image formation condition acquired from the image forming apparatus 30 and converts the read data of the printed material using the scanner profile.

### Third Embodiment

Next, a third embodiment to which the present disclosure is applied will be described.

Since the color management system according to the third embodiment has the same configuration as the color management system 100 according to the first embodiment, the same constituent elements as those according to the first embodiment are denoted by the same reference signs, and description thereof is omitted.

In the third embodiment, similarly to the second embodiment, a case where the color management apparatus 50 is the print job management apparatus according to the present disclosure will be described. Hereinafter, the third embodiment will be described focusing on the differences from the second embodiment.

In the third embodiment, color verification of the image forming apparatus 30 will be described as an operation mode in which the inline scanner 39 is used in the image forming apparatus 30.

The image forming section 36 of the image forming apparatus 30 prints a predetermined color verification chart (patch). The inline scanner 39 of the image forming apparatus 30 reads the color verification chart (printed material) and generates the read data.

The storage section 52 of the color management apparatus 50 stores a target value (reference value) in the color verification.

The CPU 51 of the color management apparatus 50 verifies, based on the read data of the color verification chart, whether the color reproduction of the image forming apparatus 30 complies with the standard. To be specific, the CPU 51 converts the read data (RGB value) of the color verification chart generated by the inline scanner 39 into the color measurement data (L^{*}a^{*}b^{*} value). The CPU 51 performs the color verification by comparing the color measurement data with the target value.

Next, the operation performed in the color management system 100 according to the third embodiment will be described.

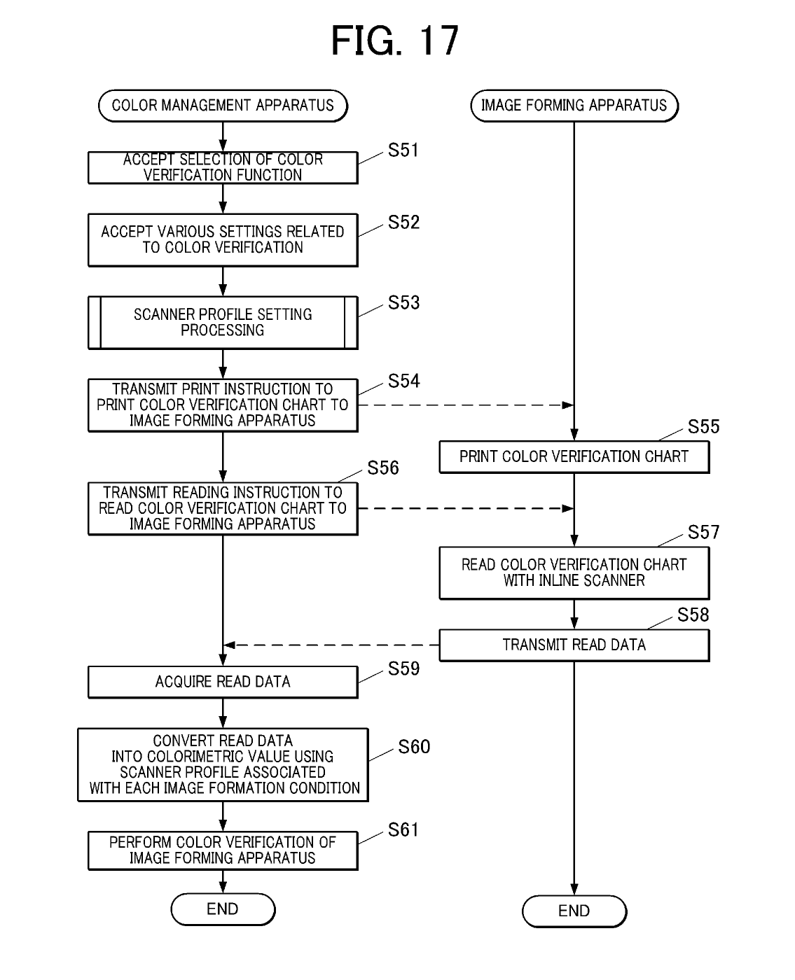

FIG. 17 is a ladder chart illustrating color verification processing executed in the color management apparatus 50 and the image forming apparatus 30.

First, in the color management apparatus 50, the CPU 51 accepts selection of the color verification function (step S51). For example, the CPU 51 causes the display part 53 to display a menu screen. The operator selects the color verification function by an operation on the operation part 54.

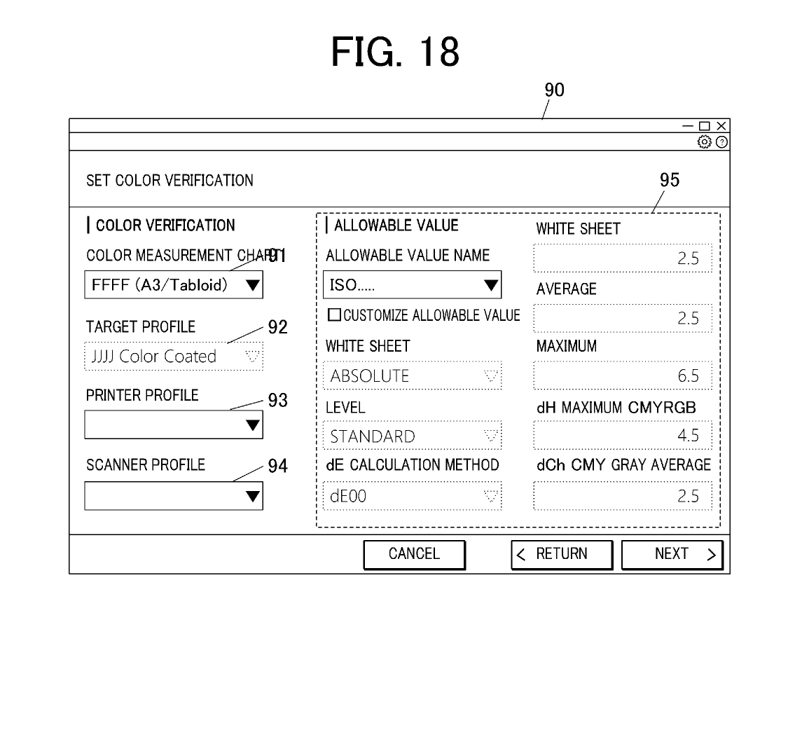

Next, the CPU 51 accepts various settings related to color verification (step S52). For example, as illustrated in FIG. 18, the CPU 51 allows the display part 53 to display a setting screen 90 for color verification. The setting screen 90 related to the color verification includes a color measurement chart selection field 91, a target profile selection field 92, a printer profile selection field 93, a scanner profile selection field 94, an allowable value setting field 95, and the like.

The color measurement chart selection field 91 is the region for selecting a color measurement chart (color verification chart). The operator selects one of the color measurement charts in the color measurement chart selection field 91 by an operation on the operation part 54.

The target profile selection field 92 is the region for selecting the target profile. The operator selects one of the target profiles in the target profile selection field 92 by an operation on the operation part 54.

The printer profile selection field 93 is the region for selecting the printer profile. The operator selects one of the printer profiles in the printer profile selection field 93 by the operation on the operation part 54.

The scanner profile selection field 94 is the region for selecting the scanner profile. When the operator wants to directly specify the scanner profile, the operator selects one of the scanner profiles in the scanner profile selection field 94 by the operation on the operation part 54.

The allowable value setting field 95 is the region for setting the allowable value for each item. The operator may collectively perform various settings related to the allowable value by selecting an allowable value name in the allowable value setting field 95 by the operation on the operation part 54. In addition, the operator may individually set the allowable value for each item by the operation on the operation part 54.

Next, the CPU 51 executes the scanner profile setting processing (step S53). The processing of step S53 is the same as the processing of step S33 in the color parameter creation processing (refer to FIG. 15). Here, the job of printing the chart used for the color verification is the "print job" in the scanner profile setting processing. The CPU 51 sets, for each of the image formation conditions, the scanner profile in association with the image formation condition, for the print job of printing the color verification chart. The CPU 51 causes the storage section 52 to store the information that indicates the correspondence relationship between the image formation condition and the scanner profile, the correspondence relationship being set for the entire print job, for each page, and for each region in the page.

The processes of step S54 to step S59 are the same as the processes of step S34 to step S39 in the color parameter creation processing (see FIG. 15) except that the chart is the color verification chart.

After step S59, the CPU 51 converts the read data (RGB value) of the color verification chart into the colorimetric value (L^{*}a^{*}b^{*} value) by using the scanner profile associated with each image formation condition related to the image formation of the color verification chart (step S60). For example, the CPU 51 specifies the scanner profile to be used from among the scanner profiles stored in the storage section 52, based on the identification information (profile name or the like) of the scanner profile associated with each image formation condition.

In a case where the scanner profile is set for the entire color verification chart in association with the same image formation condition, the CPU 51 applies the scanner profile corresponding to the image formation condition to the entire read data of the chart.

In a case where the scanner profile is set in association with the same image formation condition on a page-by-page basis of the color verification chart, the CPU 51 applies on the read data of each page the scanner profile corresponding to the image formation condition related to each page.

In a case where the scanner profile is set in association with each image formation condition for each region of the single sheet of the color verification chart, the CPU 51 applies, for each region of the read data of the single sheet of the chart, the scanner profile corresponding to the image formation condition related to the region.

Next, the CPU 51 performs color verification of the image forming apparatus 30 based on the read data (colorimetric value) of the color verification chart (step S61). To be specific, the CPU 51 compares the colorimetric value obtained from the chart printed by the image forming apparatus 30 with the color verification standard and the allowable value for each item, and determines whether the color printed by the image forming apparatus 30 satisfies the color verification standard. The CPU 51 causes the storage section 52 to store the determination result and causes the display part 53 to display the determination result.

Thus, the color verification processing ends.

According to the third embodiment, the CPU 51 of the color management apparatus 50 sets the scanner profile in association with the image formation conditions under which the image formation of the printed material is performed. Thus, the CPU 51 can apply the scanner profile suitable for the image formation condition to the read data of the printed material of which the image formation is performed under the image formation condition. Therefore, the CPU 51 can use the scanner profile suitable for each image formation condition.

In particular, in the third embodiment, the CPU 51 can set the scanner profile in association with each image formation condition used in the printing of the color verification chart.

Note that the description has been given of the case where, in the color verification processing (see FIG. 17), the read data is converted into the colorimetric value on the color management apparatus 50 side in step S60. Alternatively, the image forming apparatus 30 side may convert the read data into the colorimetric value. In this case, after step S53 and before step S58, the CPU 51 of the color management apparatus 50 transmits, to the image forming apparatus 30 via the communication section 55, the information that indicates the correspondence relationship between the image formation condition and the scanner profile, the correspondnce relationship being set for the entire print job, for each page, and for each region in a page. Next, in step S58, the CPU 31 of the image forming apparatus 30 converts the read data into the colorimetric value using the scanner profile associated with the image formation condition, the scanner profile being set for the entire print job, on a page-by-page basis, and for each region in the page, and then transmits the colorimetric value to the color management apparatus 50 via the communication section 35. The CPU 51 of the color management apparatus 50 performs the color verification based on the read data converted into the colorimetric value on the image forming apparatus 30 side.

Further, the CPU 51 of the color management apparatus 50 may acquire, from the image forming apparatus 30, the image formation condition when the image formation of the printed material (color verification chart) is actually performed. In this case, the CPU 51 sets the scanner profile on the basis of the image formation condition acquired from the image forming apparatus 30 and converts the read data of the printed material using the scanner profile.

### Fourth Embodiment

Next, the fourth embodiment to which the present disclosure is applied will be described.

Since the color management system according to the fourth embodiment has the same configuration as the color management system 100 according to the first embodiment, the same components as those according to the first embodiment are denoted by the same reference numerals, and the description thereof is omitted.

In the fourth embodiment, similarly to the second embodiment, a case where the color management apparatus 50 is the print job management apparatus according to the present disclosure will be described. Hereinafter, in the fourth embodiment, portions different from the second embodiment will be mainly described.

In the fourth embodiment, color matching based on the color sample (target output product) will be described as an operation mode in which the inline scanner 39 is used in the image forming apparatus 30. The color samples are output materials received from the customer at the time of submission, and are not data but actual output materials. In the fourth embodiment, the color of the image forming apparatus 30 is adjusted to print as intended with the color sample as the target.

The platen scanner 37 of the image forming apparatus 30 reads the color sample.

The CPU 51 of the color management apparatus 50 creates the target profile on the basis of the read data of the color sample and the document data corresponding to the color sample. The document data corresponding to the color sample is image data (CMYK value) input to a target printing machine when the color sample is printed by the target printing machine.

The image forming section 36 of the image forming apparatus 30 prints the printer profile creation chart (patch). The inline scanner 39 of the image forming apparatus 30 reads the printer profile creation chart (printed material) and generates the read data.

The CPU 51 of the color management apparatus 50 creates the printer profile of the image forming apparatus 30 on the basis of the read data of the printer profile creation chart.

The CPU 51 combines the target profile and the printer profile to create the device-link profile.

Next, the operation of the color management system 100 according to the fourth embodiment will be described.

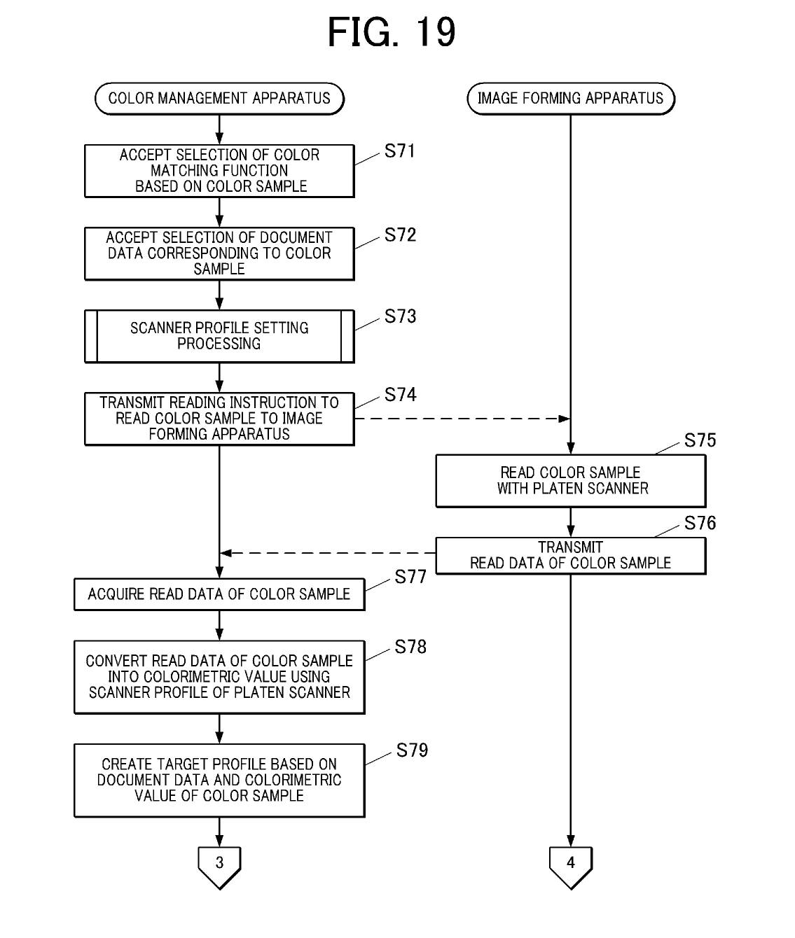

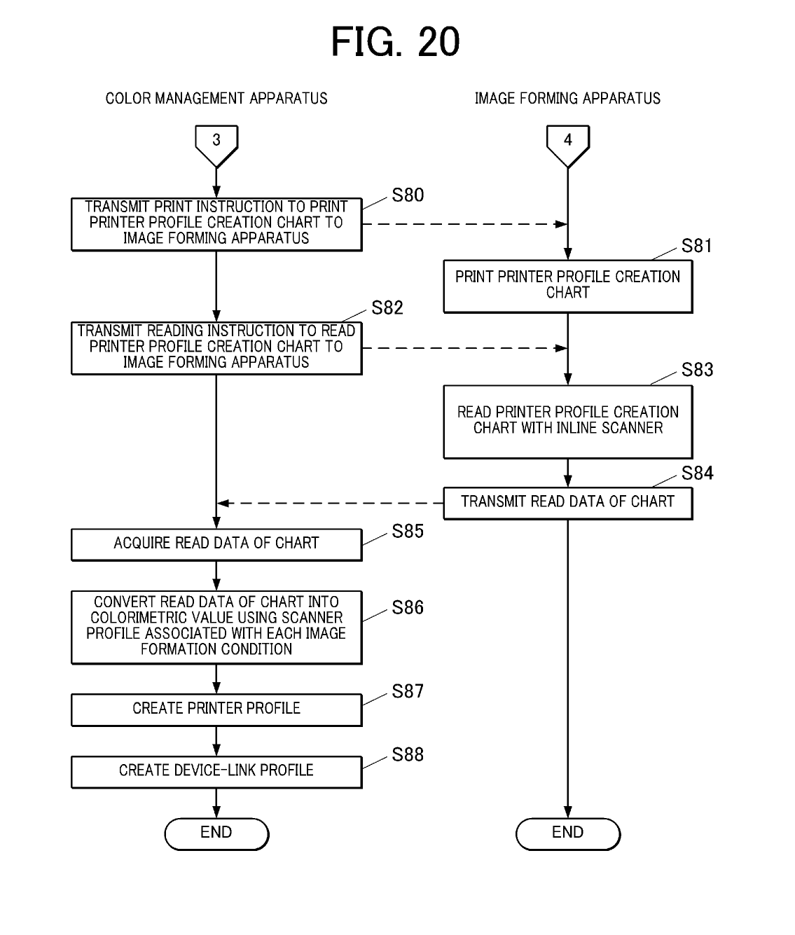

FIG. 19 and FIG. 20 are ladder charts illustrating color matching processing based on the color sample executed in the color management apparatus 50 and the image forming apparatus 30.

First, in the color management apparatus 50, the CPU 51 accepts selection of the color matching function based on the color sample (step S71). For example, the CPU 51 causes the display part 53 to display a menu screen. The operator selects the color matching function based on the color sample by the operation on the operation part 54.

Next, the CPU 51 accepts selection of the document data corresponding to the color sample (step S72). For example, the CPU 51 causes the display part 53 to display candidates for the document data. The operator selects the document data corresponding to the color sample by the operation performed on the operation part 54.

Next, the CPU 51 executes the scanner profile setting processing (step S73). The processing of step S73 is the same as the processing of step S33 in the color parameter creation processing (refer to FIG. 15). Here, the job of printing the chart (printer profile creation chart) used for color matching based on the color sample is the "print job" in the scanner profile setting processing. The CPU 51 sets, for each of the image formation conditions, the scanner profile in association with the image formation condition for the print job of printing the printer profile creation chart. The CPU 51 causes the storage section 52 to store the information that indicates the correspondence relationship between the image formation condition and the scanner profile, the correspondence relationship being set for the entire print job, for each page, and for each region in the page.

Next, the CPU 51 causes the display part 53 to display an instruction to set the color sample on the platen scanner 37 of the image forming apparatus 30. The CPU 51 transmits the reading instruction of the color sample in the platen scanner 37 to the image forming apparatus 30 via the communication section 55 (step S74).

The CPU 31 of the image forming apparatus 30 acquires the reading instruction to read the color sample from the color management apparatus 50 via the communication section 35. The CPU 31 controls the platen scanner 37 to cause it to read the color sample (step S75). The CPU 31 acquires the read data (RGB value) of the color sample from the platen scanner 37.

Next, the CPU 31 transmits the read data of the color sample to the color management apparatus 50 via the communication section 35 (step S76).

The CPU 51 of the color management apparatus 50 acquires the read data of the color sample from the image forming apparatus 30 via the communication section 55 (step S77).

Next, the CPU 51 converts the read data (RGB value) of the color sample into the colorimetric value (L^{*}a^{*}b^{*} value) using the scanner profile of the platen scanner 37 (step S78). Note that the scanner profile of the platen scanner 37 is to be reliable. Further, the CPU 51 may acquire the colorimetric value (L^{*}a^{*}b^{*} value) for the color sample from the colorimeter or the like connected to the color management apparatus 50.

Next, the CPU 51 creates the target profile based on the document data selected in step S72 and the colorimetric value of the color samples converted in step S78 (step S79). The target profile is information indicating the correspondence relationship between the document data (CMYK value) of the color sample and the colorimetric value (L^{*}a^{*}b^{*} value) obtained from the color sample. The CPU 51 creates the table in which the CMYK value and L*a*b* value are associated with each other at corresponding positions of the colorimetric value (read data) of the document data and the color sample, and creates the target profile for matching with the color of the color sample on the basis of the table.

Next, the process proceeds to FIG. 20, and the CPU 51 transmits the print instruction to print the chart (printer profile creation chart) to the image forming apparatus 30 via the communication section 55 (step S80). The print instruction of the chart may be transmitted from the color management apparatus 50 to the image forming apparatus 30 via the printer controller 20 as necessary.

The CPU 31 of the image forming apparatus 30 acquires the print instruction to print the chart from the color management apparatus 50 via the communication section 35. The CPU 31 controls the image forming section 36 on the basis of the print instruction for the chart to print the printer profile creation chart on the sheet (step S81). The printer profile creation chart may include the portion decorated and printed by the decoration forming section 41.

Next, the CPU 51 of the color management apparatus 50 transmits the reading instruction to read the chart (printer profile creation chart) to the image forming apparatus 30 via the communication section 55 (step S82).

The CPU 31 of the image forming apparatus 30 acquires the reading instruction to read the chart from the color management apparatus 50 via the communication section 35. The CPU 31 controls the inline scanner 39 to read the printer profile creation chart (printed material) (step S83). The CPU 31 acquires the read data (RGB value) of the chart from the inline scanner 39.

Next, the CPU 31 transmits the read data of the chart (printer profile creation chart) to the color management apparatus 50 via the communication section 35 (step S84).

The CPU 51 of the color management apparatus 50 acquires the read data of the chart from the image forming apparatus 30 via the communication section 55 (step S85).

Next, the CPU 51 converts the read data (RGB value) of the printer profile creation chart into the colorimetric value (L^{*}a^{*}b^{*} value) using the scanner profile associated with each image formation condition related to the image formation of the printer profile creation chart (step S86). For example, the CPU 51 specifies the scanner profile to be used from among the scanner profiles stored in the storage section 52, based on the identification information (profile name or the like) of the scanner profile associated with each image formation condition.

If the scanner profile has been set for the entire printer profile creation chart in association with the same image formation condition, the CPU 51 applies the scanner profile corresponding to the image formation condition to the entire read data of the chart.

In a case where the scanner profile is set in association with the same image formation condition for each page of the printer profile creation chart, the CPU 51 applies the scanner profile corresponding to the image formation condition related to the page on the read data of each page.

In a case where the scanner profile is set in association with each image formation condition for each region of the single sheet of the printer profile creation chart, the CPU 51 applies, for each region of the read data of the single sheet of the chart, the scanner profile corresponding to the image formation condition related to the region.

Next, the CPU 51 creates (corrects) the printer profile on the basis of the read data (colorimetric value) of the printer profile creation chart (step S87). The printer profile is the information indicating the correspondence relationship between the image data (CMYK value) for printing output to the image forming section 36 and the colorimetric value (L^{*}a^{*}b* value) of the printed material of which the image formation is performed by the image forming section 36 in the image forming apparatus 30.

Next, the CPU 51 combines the target profile and the printer profile to create the device-link profile (step S88). The CPU 51 transmits the created printer profile and the device-link profile to the image forming apparatus 30 via the communication section 55.

At the image forming apparatus 30, the CPU 31 causes the storage section 32 to store the printer profile and the device-link profile.

Thus, the color matching processing based on the color samples ends.

The CPU 31 of the image forming apparatus 30 applies the device-link profile when forming the image on the basis of the document data corresponding to the color sample. That is, the CPU 31 uses the device-link profile to convert the document data (CMYK value) into the image data (CMYK value) for printing to be output to the image forming section 36. As a result, the color of the printed material by the image forming apparatus 30 matches the color sample.

According to the fourth embodiment, the CPU 51 of the color management apparatus 50 sets the scanner profile in association with the image formation conditions under which the image formation of the printed material is performed. Thus, the CPU 51 can apply the scanner profile suitable for the image formation condition to the read data of the printed material of which the image formation is performed under the image formation condition. Therefore, the CPU 51 can use the scanner profile suitable for each image formation condition.

In particular, in the fourth embodiment, the CPU 51 can set the scanner profile in association with the image formation condition used in printing of the printer profile creation chart.

Note that the description has been given of the case where, in the color matching processing based on the color samples (see FIG. 19 and FIG. 20), the read data is converted into the colorimetric value on the color management apparatus 50 side in step S86. Alternatively, the image forming apparatus 30 side may convert the read data into the colorimetric value. In this case, after step S73 and before step S84, the CPU 51 of the color management apparatus 50 transmits, to the image forming apparatus 30 via the communication section 55, the information that indicates the correspondence relationship between the image formation condition and the scanner profile, the correspondence relationship being set for the entire print job, for each page, and for each region in the page. Next, in step S84, the CPU 31 of the image forming apparatus 30 converts the read data into colorimetric value using the scanner profile associated with the image formation condition, the scanner profile being set for the entire print job, a page unit, and the region within a page, and then transmits the colorimetric value to the color management apparatus 50 via the communication section 35. The CPU 51 of the color management apparatus 50 creates the printer profile based on the read data converted into the colorimetric value on the image forming apparatus 30 side.

Furthermore, the CPU 51 of the color management apparatus 50 may acquire, from the image forming apparatus 30, the image formation condition when the image of the printed material (printer profile creation chart) is actually formed. In this case, the CPU 51 sets the scanner profile on the basis of the image formation condition acquired from the image forming apparatus 30 and converts the read data of the printed material using the scanner profile.

Note that the description in the above embodiment is an example of the print job management method, print job management apparatus, and program included in the storage medium according to the present disclosure, and the present disclosure is not limited to this. The detailed configuration and detailed operation of each component constituting the apparatus can also be appropriately changed without departing from the scope of the present disclosure.

For example, characteristic processes in the respective embodiment may be executed in combination.

In each of the above-described embodiments, the case where the PC 10 (printer driver) or the color management apparatus 50 is the print job management apparatus according to the present disclosure has been described.

Alternatively, the printer controller 20 connected to the image forming apparatus 30 including the image forming section 36 (image forming engine) may be the print job management apparatus according to the present disclosure. In this case, the CPU 21 of the printer controller 20 sets the scanner profile in association with each image formation condition for the print job received from the PC 10. Details of the processing are the same as those in the respective embodiment described above.

Further, the image forming apparatus 30 including the image forming section 36 (image forming engine) may be the print job management apparatus according to the present disclosure. In this case, the CPU 31 of the image forming apparatus 30 sets the scanner profile in association with each image formation condition for the print job to be processed. Details of the processing are the same as those in the respective embodiment described above.

Further, in each embodiment, the processing performed by the PC 10 (printer driver) or the color management apparatus 50 may be performed by another apparatus in the color management system 100 or the apparatus connectable to the color management system 100.

For example, the function of the color management apparatus 50 may be incorporated in the PC 10, the printer controller 20 or the image forming apparatus 30, or the color management apparatus 50 may be constituted by a single apparatus.

Further, the color management apparatus 50 may provide only the Web application and the user interface, and the actual functions and data may be included in the PC 10, the printer controller 20 or the image forming apparatus 30. Further, the PC 10 may provide only the Web application and the user interface, and the actual functions and data may be included in another PC, the printer controller 20, or the image forming apparatus 30.

Furthermore, in each of the above-described embodiments, the case where the inline scanner 39 of the image forming apparatus 30 reads the printed material and generates the read data has been described. Alternatively, the operator may set the printed material on the platen scanner 37 of the image forming apparatus 30 or an external scanner, and the platen scanner 37 or the external scanner may read the printed material to generate the read data. In this case, the scanner profile set in association with the image formation condition is the scanner profile of the scanner to be used.

In each of the above-described embodiments, the case where the image forming apparatus 30 is an electrophotographic image forming apparatus that forms the image using toner has been described, but the present disclosure is not limited thereto. The image forming apparatus 30 may be an image forming apparatus of another printing method such as an inkjet method.

The computer-readable medium that stores the program for executing each processing is not limited to the above-described example. Furthermore, a carrier wave may be applied as a medium for providing data of the program via a communication line.

The disclosed embodiment is for purposes of explanation and example only, and is not intended to be limiting. The scope of the present disclosure should be interpreted by the description in the claims.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A print job management method for managing a print job to be executed on an image forming engine, the method comprising:
acquiring information of a first scanner profile for converting read data of a printed material of which image formation is performed under a first image formation condition;
setting the first scanner profile in association with the first image formation condition, based on the acquired information of the first scanner profile;
acquiring information of a second scanner profile for converting the read data of the printed material of which the image formation is performed under a second image formation condition; and
setting the second scanner profile in association with the second image formation condition based on the acquired information of the second scanner profile.

2. The print job management method according to claim 1, wherein,
the first image formation condition is the image formation condition including a color material other than color materials of four colors including cyan, magenta, yellow, and black, and
the second image formation condition is the image formation condition that does not include the color material other than the color materials of the four colors.

3. The print job management method according to claim 2, wherein the color material other than the color materials of the four colors is a white color material in a same image forming method as the color materials of the four colors.

4. The print job management method according to claim 2, wherein the color material other than the color materials of the four colors is a decoration material.

5. The print job management method according to claim 1, wherein the first scanner profile and the second scanner profile are switched in accordance with a region on a single printed material.

6. The print job management method according to claim 5, wherein the first scanner profile and the second scanner profile are switched in a direction orthogonal to a direction in which the single printed material is conveyed when the single printed material is read.

7. The print job management method according to claim 5, wherein the first scanner profile and the second scanner profile are switched in a direction in which the single printed material is conveyed when the single printed material is read.

8. The print job management method according to claim 1, wherein the first scanner profile and the second scanner profile are switched for each page included in the print job to be processed.

9. The print job management method according to claim 1, wherein the first scanner profile and the second scanner profile are switched in accordance with the print job to be processed.

10. The print job management method according to claim 1, wherein the first scanner profile and the second scanner profile are switched based on the print data corresponding to the print job to be processed.

11. A print job management apparatus comprising:
a hardware processor that executes the print job management method according to claim 1.

12. A non-transitory computer readable storage medium comprising a program that causes a computer that controls a print job management apparatus to execute the print job management method according to claim 1.
